(19) United States
(12) Patent Application Publication
(10) Pub. No.: US 2025/0012361 A1
(43) Pub. Date: Jan. 9, 2025

(54) SHAFT SEALING KIT AND SHAFT ASSEMBLY

(71) Applicant: Trelleborg Sealing Solutions Germany GmbH, Stuttgart (DE)

(72) Inventors: Tobias Corneli, Kastellaun (DE); Holger Jordan, Neuhausen a.d.F. (DE); Mandy Wilke, Böblingen (DE)

(73) Assignee: Trelleborg Sealing Solutions Germany GmbH, Stuttgart (DE)

(21) Appl. No.: 18/891,099

(22) Filed: Sep. 20, 2024

Related U.S. Application Data
(63) Continuation of application No. PCT/EP2023/052922, filed on Feb. 7, 2023.

(30) Foreign Application Priority Data
Mar. 21, 2022 (DE) 10 2022 106 567.7

(51) Int. Cl. F16J 15/20; F16C 3/02

(52) U.S. Cl. CPC F16J 15/20; F16C 3/02

(57) ABSTRACT

A shaft sealing kit for a sealing gap is formed between a shaft and a machine part engaging around the shaft. A foam ring of an elastically deformable foam material can be arranged in the sealing gap to be sealed off. The shaft sealing kit also has a kneading ring, which can be arranged in a rotationally fixed manner on the shaft and has a main body away from which there at least one cam extends which cam serves for locally compressing the foam material of the foam ring in the assembled state of the shaft sealing kit. A shaft arrangement can include a shaft sealing kit or a plurality of such shaft sealing kits.

### CROSS-REFERENCE TO RELATED APPLICATIONS

This continuation application claims priority to PCT/EP2023/052922 filed on Feb. 7, 2023 which has published as WO 2023/179955 A1 and also the German application number 10 2022 106 567.7 filed on Mar. 21, 2022, the entire contents of which are fully incorporated herein with these references.

### DESCRIPTION

### Field of the Invention

The invention relates to a shaft sealing kit and to a shaft arrangement.

### Background of the Invention

In shaft assemblies, for instance in the power train of construction vehicles, power tools, electrical handheld tools and the like, an ingress of contaminants into the bearing gap or sealing gap must be reliably avoided in order to avoid malfunctions and to ensure a sufficient service life of the shaft arrangement. To this end, in practice, packing seals, labyrinth seals and multistage sealing systems comprising a plurality of sealing rings arranged one behind the other are used for example.

### SUMMARY OF THE INVENTION

The object of the invention is to provide a shaft sealing kit and a shaft arrangement which on the one hand have a wide range of use and which allow even more reliable protection against contaminants getting into the bearing gap or sealing gap.

The object concerning the shaft sealing kit is solved by a shaft sealing kit with the features specified in the independent claim. The shaft arrangement according to the invention has the features specified in another claim. Preferred developments of the invention are specified in the subclaims and in the description.

The shaft sealing kit according to the invention is intended for a sealing gap formed between a shaft and a machine part engaging around the shaft and comprises a foam ring of an elastically deformable foam material which can be arranged in the sealing gap to be sealed off. The shaft sealing kit also comprises a kneading ring. In contrast to the foam ring, the kneading ring can be arranged or fastened in a rotationally fixed manner on the shaft or on the machine part engaging around the shaft and comprises a main body away from which at least one cam extends. The cam serves for contacting and locally compressing, i.e. deforming, the foam material of the foam ring in the assembled state of the shaft sealing kit. In operational use, the kneading ring rotates together with shaft and the at least one cam engages (nondestructively) in the foam ring and progressively compresses it in the circumferential direction, therefore thoroughly kneads it. The foam material or the foam substance of the foam ring consists of a plastic and is suitable for restraining liquid and particulate contaminants occurring on the outside from further ingress into the sealing gap, therefore taking up any contaminants that have possibly already found their way into the sealing gap and also lubricant present in the sealing gap. The foam ring can therefore serve as a sealing element, as a filter and as a lubricant reservoir. The kneading of the foam ring derived from the rotation of the shaft allows it to give off and take up (absorb and adsorb) lubricant locally. As a result, the sealing portion of an adjacently arranged sealing ring of the shaft arrangement can be reliably lubricated and thus its service life and sealing function can be improved.

Particularly preferably, the kneading ring has a plurality of cams. The cams are in this case advantageously arranged spaced apart from one another in the circumferential direction, preferably regularly. As a result, the kneading or compressing and subsequent relaxation of the foam ring can be realized with higher frequency and more effectively.

The at least one cam of the kneading ring may be designed as a radial cam or as an axial cam. As a radial cam, it extends away from the main body of the kneading ring in a direction radial to the central axis of the kneading ring. As an axial cam, it extends away from the main body of the kneading ring in a corresponding way in an axial direction. A radial cam allows the foam ring to be compressed in a radial direction and an axial cam allows it to be compressed in an axial direction.

According to a preferred embodiment of the invention, the kneading ring may have a plurality of the cams explained above. At least some of the cams may be designed as radial cams and/or as axial cams. If the kneading ring has both axial cams and radial cams, as a result particularly effective compression, i.e. particularly effective compressing or thorough kneading, of the foam ring can thus be achieved. Lubricant adsorbed or absorbed in the foam ring can in this way be squeezed out from the foam ring particularly effectively.

According to the invention, at least some of the cams of the kneading ring may coincide in geometry and/or size. Thus, the kneading ring may for example have two groups of cams which differ from one another in their size and/or geometry. As a result, the taking-up and giving-off characteristics of the foam ring with respect to fluids and also particulate contaminants can be specifically influenced.

Particularly advantageously, in the assembled state of the shaft sealing kit, the foam ring is compressible by each cam of the kneading ring respectively by at least 10%, preferably at least 15%, of its radial or axial extent. As a result, particularly effective taking-up and giving-off characteristics of the foam ring are achieved.

According to the invention, each individual cam is preferably of a rounded design, in order to avoid undesired mechanical damage to the foam ring and/or undesired co-rotation of the foam ring in operational use.

According to a preferred development of the invention, the kneading ring has at least one supporting flange for the foam ring (in order to support the foam ring in the axial direction), which extends away from the main body of the kneading ring in a radial direction. Advantageously from technical aspects of production, the supporting flange is integrally formed on the kneading ring. This allows the kneading ring to be designed as an injection-molded part that can be produced at low cost.

According to a development of the invention, the kneading ring has two supporting flanges, between which the foam ring can be arranged. The kneading ring thus forms an annular groove for the foam ring, by which the foam ring can be fixed in position relative to the kneading ring in an axial direction.

If the kneading ring is provided with axial cams, the foam ring can support itself on one of the side flanges of the kneading ring. This side flange therefore serves the foam ring as an axial abutment.

According to the invention, the kneading ring may consist of metal, a plastic or else of a composite material. It goes without saying that the material of the kneading ring preferably has a greater modulus of elasticity than the foam material of the foam ring.

The kneading ring may in particular consist of a viscoelastically deformable plastic. Coming into consideration for this are for example polyamides (for example PA6), acrylonitrile-butadiene-styrene copolymers, polycarbonates (PC), etc.

According to the invention, the foam material of the foam ring is preferably at least partly of an open cell (=open pore) or mixed open-closed cell (=mixed open-closed pore) form. The foam material may be for example a polyethylene (=PE) foam or a polyurethane (PU) foam.

The shaft arrangement according to the invention comprises: a first machine part in the form of a shaft and a second machine part engaging around the shaft, wherein the two machine parts are arranged spaced apart from one another to form a sealing gap and are arranged rotatably relative to one another about an axis of rotation; and at least one shaft sealing kit explained above, wherein the foam ring is arranged in the sealing gap and the kneading ring is arranged in a rotationally fixed manner on the shaft or on the second machine part in such a way that, when there is a relative movement of the two machine parts, the foam ring is progressively compressed in the direction of rotation by the cams of the kneading ring.

In the case of the shaft arrangement according to the invention, the interaction of the kneading ring with the foam ring is therefore used for thoroughly kneading the foam ring around its periphery. As a consequence, the foam ring can give off lubricant it has taken up, as well as contaminants such as fluids and particles, and locally take them up again after its respective local compression region has been relieved of load. At a sufficiently high rotational speed of the shaft, contaminants adsorbed on or mechanically attached to the foam ring can be swept away from the foam ring. The foam ring may be arranged such that it is held, in particular clamped, in a rotationally fixed manner on the other machine part respectively, on which the kneading ring is not fastened.

According to a preferred development of the invention, the surface of the kneading ring between its individual cams contacts the foam ring without compressing it or is arranged at a distance from it. As a result, on account of its intrinsic elastic resilience, the foam ring is given the possibility of unfolding or re-deforming into its original shape after compression by a cam of the kneading ring has taken place.

According to the invention, the shaft arrangement preferably comprises a sealing ring with a dynamic sealing portion or a sealing edge, which lies peripherally against the shaft in a dynamically sealing manner. The shaft sealing kit may be arranged offset with respect to this sealing ring in an axial direction toward the contaminated side or outside of the sealing gap. In this case, the foam ring may as it were serve as a first protective barrier against contaminants getting into the sealing gap.

According to an alternative form of development of the invention, the shaft sealing kit is arranged offset with respect to the sealing ring in an axial direction toward the inside or clean side of the sealing gap. Here, the foam ring may serve as a lubricant reservoir and as a dirt barrier for contaminants that occur in the sealing gap (abrasive matter, oil carbon deposits etc.) or have breached the seal.

Particularly preferably, the shaft arrangement comprises a plurality of sealing rings, which are arranged spaced apart from one another in an axial direction, wherein a shaft sealing kit is respectively arranged between two or all of the sealing rings lying next to one another in pairs. Each foam ring of a shaft sealing kit may in this case lie respectively with its two side flanks in interlocking engagement against one of the sealing rings, in particular over its entire radial extent. As a result, the foam ring may have a (certain) supporting function for the sealing rings. In addition, each foam ring can thus be fixed in position relative to the shaft, in its specified axial position, in a simple way in terms of structural design. If the foam ring is arranged such that it is held (clamped) under axial preloading (precompression) between two of the sealing rings in each case, an undesired co-rotation of the foam ring with the shaft can in this way be reliably counteracted.

According to the invention, each foam ring may be indirectly or directly supported at the outer circumference in a radial direction on the second machine part or on a mounting sleeve.

According to the invention, each sealing ring and the foam ring of each shaft sealing kit may be arranged together in a machine part formed as a mounting sleeve. The mounting sleeve may be mounted on a further housing part or the like. Such mounting sleeves may consist of different materials, for instance metal, a viscoelastically or itself rubber-elastically deformable plastic and also a composite material. Such a mounting sleeve allows the bearing and mounting of the individual components to be simplified considerably. This is of advantage for the production costs.

The invention is explained in more detail below on the basis of exemplary embodiments reproduced in the drawing. The embodiments shown and described should not be understood as an exhaustive enumeration, but rather are of an exemplary character for outlining the invention.

### BRIEF DESCRIPTION OF THE DRAWINGS

In the drawings:

FIG. 1 shows a first shaft arrangement with a shaft, a machine part engaging around the shaft at a distance, a first and a second sealing ring and also a shaft sealing kit, which is arranged between the two sealing rings and comprises a foam ring, which is arranged in the sealing gap, and a kneading ring, which is arranged on the shaft for co-rotation and interacts with the foam ring, in a sectional view of a detail;

FIG. 2 shows a kneading ring in a perspective view;

FIG. 3 shows a second shaft arrangement, which differs from the shaft arrangement shown in FIG. 1 essentially by sealing rings with a different sealing direction;

FIG. 4 shows a third shaft arrangement with three sealing rings, which are arranged lying one behind the other in the axial direction, a shaft sealing kit being arranged between two of the sealing rings in each case;

FIG. 5 shows a fourth shaft arrangement with four sealing rings, acting in the same direction and arranged lying one behind the other in the axial direction, a shaft sealing kit being arranged between two of the sealing rings in each case;

FIG. 6 shows a shaft arrangement with a conventional sealing ring having a stripping lip, which lies with its sealing lip spring-preloaded peripherally against the shaft in a dynamically sealing manner, and with a shaft sealing kit arranged ahead of the sealing ring toward the outside in the axial direction;

FIG. 7 shows a kneading ring with a plurality of radial cams, which are arranged spaced apart from one another in the circumferential direction of the kneading ring, and with two side flanges, in a perspective view;

FIG. 8 shows the kneading ring according to FIG. 7 in a side view;

FIG. 9 shows a kneading ring with radial and axial cams and also with two side flanges, in a perspective view;

FIG. 10 shows the kneading ring according to FIG. 9, in a sectional view; and

FIG. 11 shows a kneading ring with radial cams and with a side flange extending beyond the radial cams in the radial direction.

### DETAILED DESCRIPTION OF EMBODIMENTS OF THE INVENTION

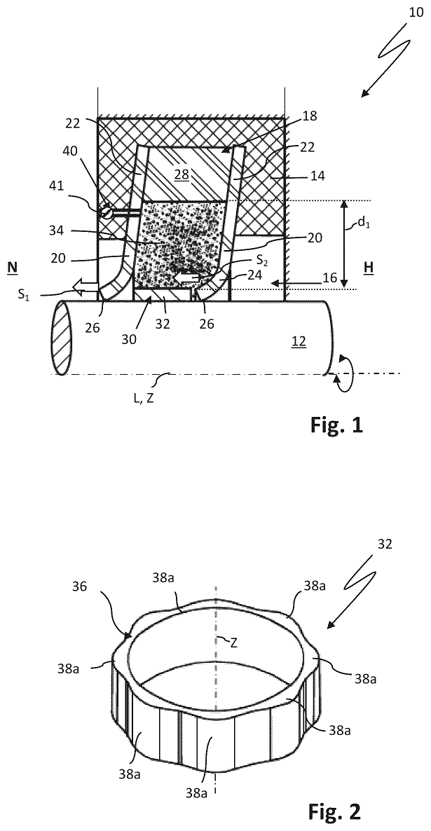

FIG. 1 shows a shaft arrangement 10 comprising a shaft 12, a machine part 14 engaging around the shaft 12, for example in the form of a shaft housing or a mounting sleeve. The shaft 12 is arranged at a distance from the machine part 14 to form a bearing gap or sealing gap 16 and is mounted rotatably about an axis of rotation denoted by L. The machine part 14 has a holding groove 18. One or more sealing rings 20 serve for sealing off an inside H of the sealing gap 16 with respect to an outside N of the sealing gap 16. The term sealing ring is understood as also including so-called stripping rings. The sealing rings 20 are arranged with their mounting or foot portions 22 respectively held in the holding groove 18 of the machine part 14. The sealing rings 20 respectively have a sealing lip 24, which is integrally formed on the holding portion and has a sealing edge 26, which lies fully peripherally against the shaft 12 in a dynamically sealing manner. Here, the sealing edges 24 have coinciding effective or sealing directions S₁, S₂ (toward the outside). The sealing rings 20 are kept at a distance by a clamping element 28 arranged between the foot portions 22. The clamping element 28 is arranged between the foot portions 22 of the two sealing rings 20 in the axial direction. The clamping element 28 is preferably designed as annually closed and preferably comprises a material with a greater modulus of elasticity than the material of the sealing rings 20.

Furthermore, a shaft sealing kit denoted overall by 30 is arranged between the sealing lips 24 of the sealing rings 20. The shaft sealing kit 30 is delimited in a radial direction by the clamping element 28 and the shaft. The shaft sealing kit 30 comprises a kneading ring 32 and a foam ring 34. The kneading ring 32 is arranged on the shaft 12 for co-rotation and fixed axially in position. The kneading ring 32 may in this respect be fastened on the shaft in particular with a clamping fit or by an adhesive connection. The foam ring 34 is arranged between the two sealing rings 20, here their sealing lips 24, and in addition between the two foot portions 22. The foam ring 34 may lie peripherally on both sides against the sealing rings 20 almost over its entire radial extent. In addition, in a radial direction the foam ring lies on the outside against the machine part 14 by way of the clamping element 28 and is supported on it. Here, in the radial direction the foam ring 34 lies on the inside against the kneading ring 32.

According to the exposed perspective view of the kneading ring 32 shown in FIG. 2, the kneading ring 32 comprises a main body 36, on which projections or radial cams 38a are arranged, in particular integrally formed. The radial cams 38a extend here respectively away from the main body 36 in a direction radial to the central axis Z of the kneading ring 32. Here, the radial cams 38a are rounded and of the same design, but may also differ from one another in their size and geometry. It should be noted that the central axis of the kneading ring 32 and the axis of rotation L of the shaft arrangement coincide in the assembled state of the kneading ring.

The kneading ring 32 may consist of metal, a plastic, preferably a viscoelastically deformable plastic, or a composite material. According to an embodiment that is not shown in more detail in the drawing, the kneading ring 32 may also be of a multi-part, in particular two-part, design, in order to simplify further its mounting on the shaft 12. In the case of this embodiment, the kneading ring 32 may for example comprise two half shells (not shown in the drawing), which can be locked together by latching means. In principle, the shaft sealing kit can also be retrofitted on existing shafts.

In the assembled state, shown in FIG. 1, of the shaft sealing kit 30, the radial cams 38a of the kneading ring 32 engage in a displacing manner in the foam material of the foam ring 34. The foam ring 34 is locally compressible by each radial cam 38a of the kneading ring 32 respectively by at least 10% of its here relevant—radial—extent d₁. If the shaft 12 rotates about the axis of rotation L, the kneading ring 32 rotates together with the shaft 12 about the axis of rotation L. The radial cams 38a of the kneading ring 32 are thereby moved through the foam material of the foam ring 34, with accompanying deformation of the foam ring 34 in the respective direction of rotation of the shaft 12. The foam ring 34 is therefore thoroughly kneaded. If the foam ring 34 is impregnated with a lubricant, which is typically arranged in the sealing gap, as a result the lubricant can be partially displaced from the foam ring 34, i.e. squeezed out. If the respective radial cam 38a moves on further, the foam ring 34 can relax again locally at the previous position of the respective radial cam 38a in the foam ring 34, i.e. can resume its original shape on account of its intrinsic elastic resilience.

The shaft arrangement 10 may have an exhaust or outlet duct 40, by way of which the foam ring 34 and the outside N are fluidically connected to one another. According to FIG. 1, the outlet duct 40 may extend from the outside N through the machine part 14, the first sealing ring 20 closest to the outside to the base of the foam ring 34. The outlet duct 40 allows lubricant and particulate contaminants to be discharged from the foam ring 34 to the outside N. This corresponds to a self-cleaning of the bearing or sealing gap 16. The exhaust duct may be provided with a unidirectional valve 41. Undesired ingress of contaminants via the outlet duct 40 into the sealing gap 16 can be prevented by the valve.

The machine part 14 may if need be also be formed by a mounting sleeve. The mounting sleeve may consist of a viscoelastically or rubber-elastically deformable material familiar to a person skilled in the art.

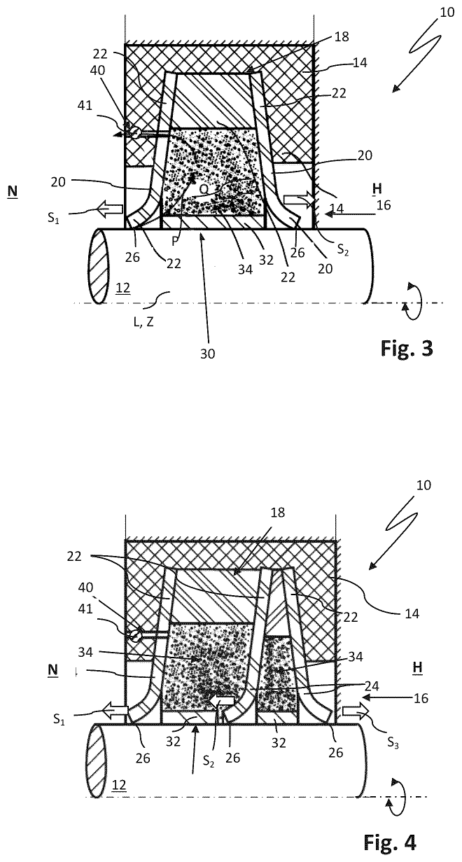

FIG. 3 shows a further shaft arrangement 10, which differs from that shown in FIG. 1 essentially in that the two sealing rings 20 have opposite sealing directions S₁, S₂.

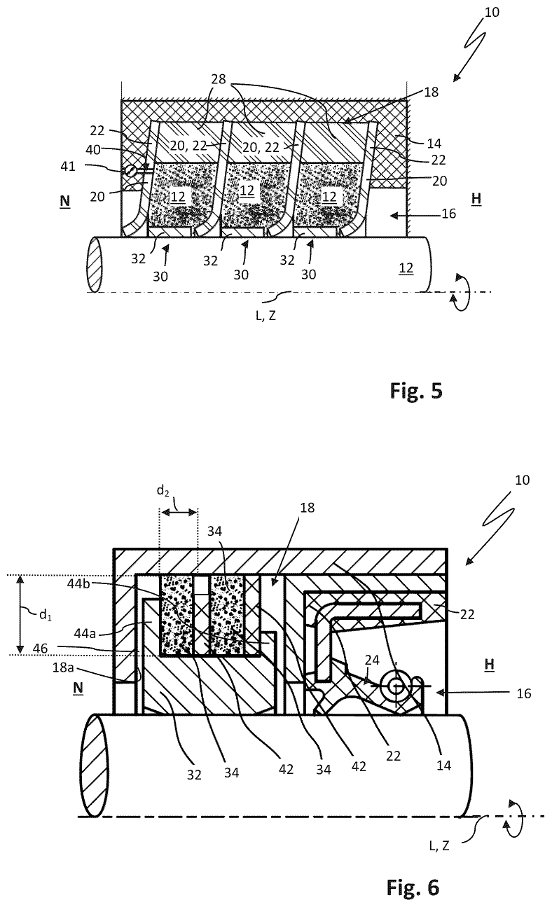

According to FIGS. 4 and 5, the shaft arrangement may also have three or more sealing rings 20 with coinciding or else sometimes opposite effective or sealing directions S₁, S₂, S₃ (FIG. 4). It should be noted that a shaft sealing kit 30 may be arranged between two of the sealing rings 20 in each case. The foam ring 34 of each shaft sealing kit 30 may lie in the axial direction on both sides against the sealing rings 20 assigned to the respective foam ring 34.

FIG. 6 shows a shaft arrangement 10, in which the shaft sealing kit 30 is arranged offset relative to the sealing ring 20 or the sealing rings 20 of the shaft arrangement 10 by way of example in an axial direction toward the outside N. The shaft sealing kit 30 is therefore arranged ahead of the sealing ring 20 on the outside. The shaft sealing kit 30 may have at least one foam ring 34 or else, according to FIG. 6, two foam rings 34, which are arranged spaced apart from one another in the axial direction. A holding ring or spacer ring 42 may be respectively arranged between the foam rings 34 and between the side flange 44b and the adjacent foam ring 34. The kneading ring 32 for the foam ring or foam rings 34 may have on the outside a first supporting flange 44a and on the inside a second supporting flange 44b.

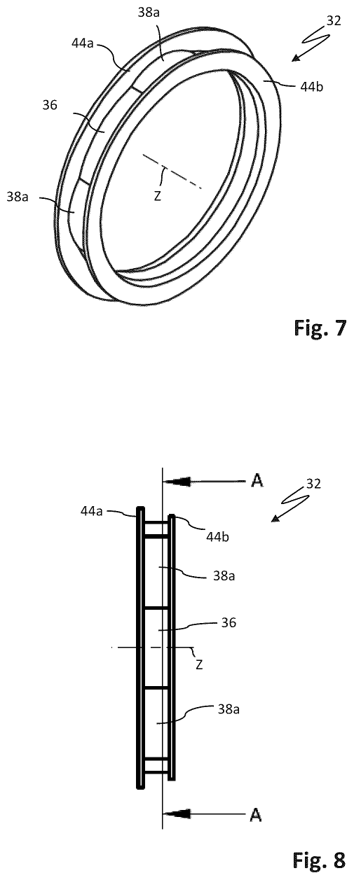

According to the view of an exposed detail of the kneading ring 32 of FIGS. 7 and 8, each supporting flange 44 extends in a radial direction outward away from the main body 36 of the kneading ring 32. The outer supporting flange 44a may in this case project beyond the inner second supporting flange 44b in the radial direction.

According to FIG. 6, the shaft sealing kit 30 is arranged together with the sealing ring 20 in the holding groove 18 of the machine part 14 (or of the mounting sleeve). The holding groove 18 is delimited on the outside by a groove flank 18a. Arranged between the groove flank 18a and the kneading ring 32 is a (narrow) fluid duct 46, which is open toward the outside N and forms with the foam rings 34 of the shaft sealing kit 30 a kind of labyrinth seal. The sealing ring 20 may be of any common shaping and, as shown in FIG. 6, may have a foot portion 22 and a pressure-activatable sealing lip 24 with a sealing edge 26, which is preloaded in a sealing manner against the shaft 12 by means of a preloading element 48, in particular a worm spring. It goes without saying that the sealing ring 20 may have a reinforcing insert, etc.

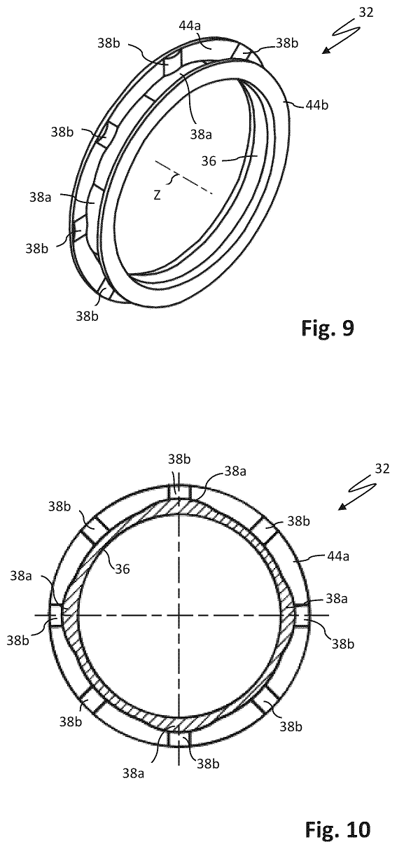

FIGS. 9 and 10 show a further kneading ring 32 in an exposed view. The kneading ring 32 has both radial cams 38a and axial cams 38b and can be used for example in the case of the shaft arrangement shown in FIG. 6. Axial and/or radial cams 38a, 38b may be respectively arranged regularly or else irregularly spaced apart from one another in the circumferential direction. The radial cams 38a and the axial cams 38b may also coincide in their size and/or geometry or differ from one another. The radial cams 38a may be arranged at least partially offset with a gap in relation to the axial cams 38b and or be aligned with them in the axial direction. The radial cams 38a are suitable for compressing the foam rings 34 shown in FIG. 6 in the radial direction of their extent d₁ by at least 10%. The axial cams are in a corresponding way suitable for compressing the foam ring on the left in FIG. 6 locally by 10% of its axial extent d₂.

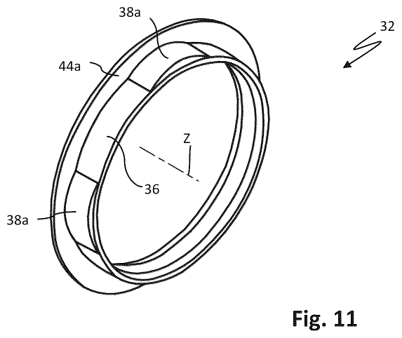

FIG. 11 shows a further kneading ring 32, which differs from the embodiment of the kneading ring 32 shown in FIG. 7 essentially in that the kneading ring 32 has only one supporting flange 44a, 44b.

To sum up, the invention relates to a shaft sealing kit (30) for a sealing gap formed between a shaft (12) and a machine part (14) engaging around the shaft (12), comprising a foam ring (34) of an elastically deformable foam material which can be arranged in the sealing gap (16). The shaft sealing kit also comprises a kneading ring (32), which can be arranged in a rotationally fixed manner on the shaft (12) and has a main body (36) away from which at least one cam (38a, 38b) extends, which cam serves for locally compressing the foam material of the foam ring in the assembled state of the shaft sealing kit. The invention additionally relates to a shaft arrangement with such a shaft sealing kit (30) or with a plurality of such shaft sealing kits (30).

What is claimed is:

1. A shaft sealing kit for a sealing gap formed between a shaft and a machine part engaging around the shaft, wherein the shaft and the machine part are adjustable relative to one another about an axis of rotation L, comprising
a foam ring of an elastically deformable foam material configured to be arranged in the sealing gap to be sealed off; and
a kneading ring, configured to be arranged in a rotationally fixed manner on the shaft or on the machine part and has a main body away from which at least one cam extends, which engages in a displacing manner in the foam ring in the assembled state of the shaft sealing kit.

2. The shaft sealing kit as claimed in claim 1, wherein the kneading ring has a plurality of cams, which are arranged spaced apart from one another in the circumferential direction of the kneading ring.

3. The shaft sealing kit as claimed in claim 2, wherein at least some of the cams are radial cams.

4. The shaft sealing kit as claimed in claim 2, wherein at least some of the cams are axial cams.

5. The shaft sealing kit as claimed in claim 1, wherein, in the assembled state of the shaft sealing kit, the foam ring is compressible by each cam respectively by at least 10% of its radial or axial extent (d₁, d₂).

6. The shaft sealing kit as claimed in claim 1, wherein each cam is of a rounded design.

7. The shaft sealing kit as claimed in claim 2, wherein at least some of the cams of the kneading ring coincide in their geometry and/or size.

8. The shaft sealing kit as claimed in claim 1, wherein the kneading ring has at least one supporting flange for the foam ring, which extends away from the main body of the kneading ring in a radial direction.

9. The shaft sealing kit as claimed in claim 8, wherein the kneading ring has two supporting flanges, between which the foam ring engages in the assembled state of the shaft sealing kit.

10. The shaft sealing kit as claimed in claim 1, wherein the kneading ring consists of metal, plastic or a composite material or in that the kneading ring is an injection-molded part.

11. The shaft sealing kit as claimed in claim 1, wherein the foam material of the foam ring is at least partly an open cell or mixed cell foam.

12. A shaft arrangement including the shaft sealing kit as claimed in claim 1, the shaft arrangement comprising:
a first machine part in the form of the shaft and the machine part being a second machine part engaging around the shaft, which are arranged rotatably relative to one another about an axis of rotation L thereby forming the sealing gap; and
at least one of the shaft sealing kit, wherein the foam ring of the shaft sealing kit is arranged in the sealing gap and the kneading ring is arranged in a rotationally fixed manner on the other machine part respectively wherein, when the shaft is rotating, the foam ring is progressively compressed in the direction of rotation of the shaft by each cam of the kneading ring.

13. The shaft arrangement as claimed in claim 12, wherein the foam ring fully peripherally contacts the kneading ring or is in sections at a distance from it in the circumferential direction.

14. The shaft arrangement as claimed in claim 12, wherein the shaft arrangement comprises at least one sealing ring with a sealing edge, which lies peripherally against the shaft in a dynamically sealing manner.

15. The shaft arrangement as claimed in claim 12, wherein the shaft sealing kit is arranged offset with respect to the sealing ring in an axial direction toward the outside N of the sealing gap.

16. The shaft arrangement as claimed in claim 12, wherein the shaft sealing kit is arranged offset with respect to the sealing ring in an axial direction toward the inside H of the sealing gap.

17. The shaft arrangement as claimed in claim 12, wherein the shaft arrangement has a plurality of sealing rings, which are arranged lying one behind the other in an axial direction, wherein a shaft sealing kit is respectively arranged between two of the sealing rings lying next to one another in pairs.

18. The shaft arrangement as claimed in claim 17, wherein each foam ring lies respectively with its two side flanks in interlocking engagement against one of the sealing rings.

19. The shaft arrangement as claimed in claim 12, wherein each foam ring is indirectly or directly supported at the outer circumference in a radial direction on the second machine part.

20. The shaft arrangement as claimed in claim 12, wherein each sealing ring and the foam ring of each shaft sealing kit are arranged wherein they are held together in a machine part formed as a mounting sleeve.

21. The shaft arrangement as claimed in claim 12, wherein the foam ring is arranged for conjoint rotation on one of the two machine parts.

22. The shaft arrangement as claimed in claim 17, wherein each foam ring lies respectively with its two side flanks in interlocking engagement against one of the sealing rings over its entire radial extent.
